(19) United States
(12) Patent Application Publication
(10) Pub. No.: US 2024/0127075 A1
(43) Pub. Date: Apr. 18, 2024

(54) SYNTHETIC DATASET GENERATOR

(71) Applicant: NVIDIA Corporation, Santa Clara, CA (US)

(72) Inventors: Shalini De Mello, San Francisco, CA (US); Christian Jacobsen, Ann Arbor, MI (US); Xunlei Wu, Cary, NC (US); Stephen Tyree, University City, MO (US); Alice Li, Santa Clara, CA (US); Wonmin Byeon, Santa Cruz, CA (US); Shangru Li, Philadelphia, PA (US)

(73) Assignee: NVIDIA Corporation, Santa Clara, CA (US)

(21) Appl. No.: 18/212,629

(22) Filed: Jun. 21, 2023

Related U.S. Application Data
(60) Provisional application No. 63/415,937, filed on Oct. 13, 2022.

(51) Int. Cl. G06N 3/0985

(52) U.S. Cl. CPC G06N 3/0985

(57) ABSTRACT

Machine learning is a process that learns a model from a given dataset, where the model can then be used to make a prediction about new data. In order to reduce the costs associated with collecting and labeling real world datasets for use in training the model, computer processes can synthetically generate datasets which simulate real world data. The present disclosure improves the effectiveness of such synthetic datasets for training machine learning models used in real world applications, in particular by generating a synthetic dataset that is specifically targeted to a specified downstream task (e.g. a particular computer vision task, a particular natural language processing task, etc.).

### RELATED APPLICATION(S)

This application claims the benefit of U.S. Provisional Application No. 63/415,937 (Attorney Docket No. NVIDP1362+/22-SC-1350US01), titled “ACTIVE/ONLINE TRAINING DATA CURATION AND SYNTHESIS” and filed Oct. 13, 2022, the entire contents of which is incorporated herein by reference.

### TECHNICAL FIELD

The present disclosure relates to generating synthetic training data for use in training machine learning models.

### BACKGROUND

Machine learning is an artificial intelligence technique that involves a computer process learning a model from a given dataset, where the model can then be used to make a prediction about new data. Thus, machine learning allows for the model to be learned from data, instead of being defined as a preconfigured equation. As noted, machine learning relies on a given dataset to train the model, such that the accuracy of the model is directly tied to the quality of the dataset.

Conventionally, machine learning models have been trained on real world datasets, or in other words real world data records or other data captured in the real world, which are usually manually labeled with the information needed to use machine learning to learn a relevant model. For example, a model which predicts a classification of an object in an image may be trained on a dataset of real world images of objects which have been labeled with their respective object classifications. However, while training models on increasingly larger real world datasets has been shown to improve accuracy of such models when used for a downstream task, gathering large real world datasets can be prohibitively expensive, for example due to the collecting and required labeling of the real world data.

To address this issue, training machine learning models on synthetically generated data has gained much traction in recent years with the aim of greatly reducing costs associated with collecting and labeling real world datasets. Generating datasets entirely from synthetic generation processes can greatly reduce costs and allows for more control during development. On the other hand, these models cannot effectively be used in a real world domain (i.e. to make predictions on real world data), especially since the latest synthetic generation processes rely on domain randomization without consideration of the particular downstream task for which the model will be used. As a result, the gap between the synthetic and real world domains causes poor generalization of the model to real world applications.

There is thus a need for addressing these issues and/or other issues associated with the prior art. For example, there is a need for generating a synthetic dataset usable for training a machine learning model, where the synthetic dataset specifically targets a specified downstream task.

### SUMMARY

A method, computer readable medium, and system are disclosed for generating a synthetic dataset. An input dataset is processed to generate a synthetic dataset that targets a specified downstream task. Furthermore, the synthetic dataset is output.

### BRIEF DESCRIPTION OF THE DRAWINGS

FIG. 1 illustrates a method for generating a synthetic dataset, in accordance with an embodiment.

FIG. 2 illustrates a method for weighting samples in an input synthetic dataset, in accordance with an embodiment.

FIG. 3 illustrates a method for curating an input dataset to form a synthetic dataset, in accordance with an embodiment.

FIG. 4 illustrates a flow diagram of a system that curates a synthetic dataset from an input dataset, in accordance with an embodiment.

FIG. 5 illustrates a method for actively synthesizing an input dataset to form a smaller synthetic dataset, in accordance with an embodiment.

FIG. 6 illustrates a flow diagram of a system that actively synthesizes a synthetic dataset from an input dataset, in accordance with an embodiment.

FIG. 7 illustrates a method for using a machine learning model in a downstream task, in accordance with an embodiment.

FIG. 8A illustrates inference and/or training logic, according to at least one embodiment;

FIG. 8B illustrates inference and/or training logic, according to at least one embodiment;

FIG. 9 illustrates training and deployment of a neural network, according to at least one embodiment;

FIG. 10 illustrates an example data center system, according to at least one embodiment.

### DETAILED DESCRIPTION

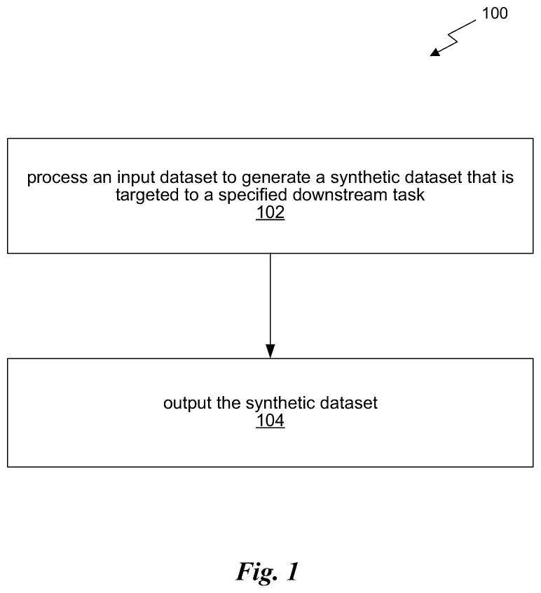

FIG. 1 illustrates a method 100 for generating a synthetic dataset, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, an input dataset is processed to generate a synthetic dataset that targets a specified downstream task. With respect to the present description, the input dataset refers to a set of data that is input (e.g. accessed, collected, etc.) for the purpose of being processed to generate a synthetic dataset that targets a specified downstream task. In an embodiment, the input dataset includes an input synthetic dataset, or in other words a synthetically generated portion of data (i.e. generated by a computer process that is at least partially automated). In an embodiment, the input dataset includes an input real world dataset, or in other words, a portion of data captured from the real world (e.g. captured in camera images, video, etc.).

In an embodiment where the input dataset includes both the input synthetic dataset and the input real world dataset, the input synthetic dataset may include a greater number of samples than the input real world dataset. In an embodiment, the input dataset, such as the input synthetic dataset and/or the input real world dataset, may include labeled samples. The labels may be specific to the downstream task (e.g. usable for training a machine learning model for the downstream task). In an embodiment, the downstream task may be represented in the labeled real world dataset samples. The downstream task may be a computer vision task (e.g. object detection, segmentation, etc.), a natural language processing task, etc.

As mentioned above, the input dataset is processed to generate the synthetic dataset that targets a specified downstream task. The synthetic dataset, which is generated by processing the input dataset, refers to a set of data which is generated by a computer process that is at least partially automated, and which is targeted to the specified downstream task. Thus, in an embodiment, the synthetic dataset does not include data collected (e.g. captured) from the real world, such as images of the real world, etc.

In an embodiment, the synthetic dataset that targets the specified downstream task may be curated from the input dataset. Accordingly, processing the input dataset may include curating (e.g. reducing, culling, etc.) the input dataset. For example, a defined number of top-weighted synthetic samples included in the input dataset may be determined, and the top-weighted synthetic samples may be selected as the synthetic dataset (e.g. with remaining synthetic samples removed).

In another embodiment, the synthetic dataset may be synthesized from the input dataset. Accordingly, processing the input dataset may include synthesizing (e.g. growing, augmenting, etc.) the input dataset. For example, the synthetic dataset may include newly generated synthetic samples that augment the input dataset. In an embodiment, the newly generated synthetic samples may include additional synthetic samples generated over a plurality of iterations. In an embodiment, the newly generated synthetic samples may include additional synthetic samples generated by: determining a defined number of top-weighted synthetic samples included in the input dataset, computing a generative parameter distribution of the top-weighted synthetic samples included in the input dataset, selecting a plurality of synthesis parameters, based on the generative parameter distribution, and generating the additional synthetic samples based on the plurality of synthesis parameters.

In an embodiment, the processing may be performed using a meta-learning algorithm. In an embodiment, the meta-learning algorithm may reweight a plurality of synthetic samples included in the input dataset. The sample weights resulting from the reweighting may be used for the input dataset curation and/or input dataset synthesis described above.

In an embodiment, processing the input dataset may include learning, with respect to the target downstream task for each of a plurality of synthetic samples included in the input dataset, an importance of the synthetic sample and its generation parameters. In an embodiment, the importance may be indicated as a weight. The weight may be determined via the reweighting mentioned above. In an embodiment, the synthetic dataset may then be generated based on the importance learned for each of the plurality of synthetic samples included in the input dataset.

The synthetic dataset is generated to target the specified downstream task by taking the specified downstream task into consideration during the processing of the input dataset. In an embodiment where the input dataset includes the input synthetic dataset and the input real world dataset, the input synthetic dataset samples may be reweighted, as described above, based on the input real world dataset samples. For example, the reweighting of the input synthetic dataset samples may be performed with respect to a loss on the real world dataset per the downstream task. In an embodiment, the synthetic dataset may accordingly be optimized for the downstream task.

In operation 104, the synthetic dataset is output. The synthetic dataset may be output for any desired purpose. In an embodiment, the synthetic dataset is output as a training dataset for training a machine learning model for the target downstream task. In an embodiment, the method 100 may further include training the machine learning model for the target downstream task, using the synthetic dataset. By training the machine learning model on the synthetic dataset that has been generated to specifically target the downstream task, performance of the machine learning model may be improved with reduced training and dataset rendering costs.

It should be noted that the method 100 may be performed to generate a synthetic dataset for any specified downstream task. Accordingly, the method 200 may be repeated, as desired, to generate different synthetic datasets targeting different downstream tasks.

Further embodiments will now be provided in the description of the subsequent figures. It should be noted that the embodiments disclosed herein with reference to the method 100 of FIG. 1 may apply to and/or be used in combination with any of the embodiments of the remaining figures below. It should be noted that the synthetic dataset generated in accordance with the method 100 may be referred to in the descriptions below as an output synthetic dataset, in order to differentiate such synthetic dataset from the input synthetic dataset mentioned above and elsewhere in the disclosed embodiments.

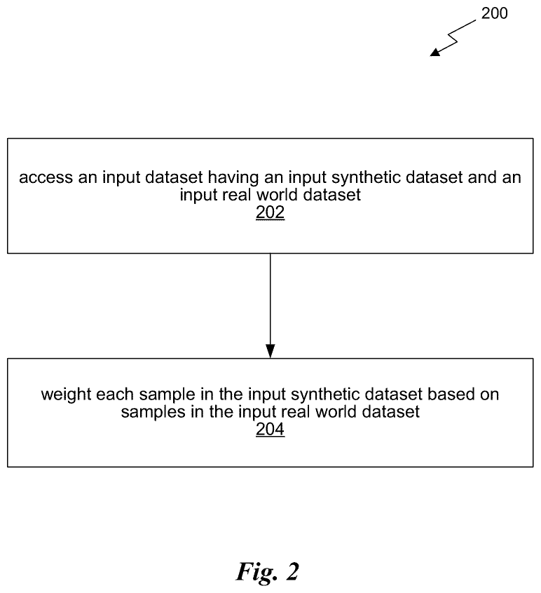

FIG. 2 illustrates a method 200 for weighting samples in an input synthetic dataset, in accordance with an embodiment. The method 200 may be performed in accordance with the method 100 of FIG. 1. For example, the method 200 may be used to determine weights of the input synthetic dataset samples, which in turn may be used to curate and/or synthesize an input synthetic dataset to form an output synthetic dataset that targets a downstream task. The definitions and embodiments described above may equally apply to the description of the present embodiment.

In operation 202, an input dataset having an input synthetic dataset and an input real world dataset is accessed. The input synthetic dataset and the input real world dataset may be accessed from the same or different repositories. The input synthetic dataset and the input real world dataset may be labeled for a specified downstream task.

In operation 204, each sample in the input synthetic dataset is weighted based on samples in the input real world dataset. In an embodiment, this may include reweighting the input synthetic dataset samples based on the input real world dataset samples. In an embodiment, the reweighting of the input synthetic dataset samples may be performed with respect to a loss on the real world dataset per the downstream task.

Exemplary Implementation of the Method 200

The method 200 may be implemented as an optimization-based meta-learning reweighting algorithm. The method 200 accesses (i.e. takes as input) an input synthetic dataset of N samples and an input (representative) real world dataset of M samples, where in an embodiment N>>M, and the method 200 outputs a set of N weights {w} corresponding to each of the samples in the input synthetic dataset. To perform the reweighting, the downstream task must also be specified, in particular so that the weights learned on the input synthetic dataset are therefore specific to a specified downstream task. The loss used to train the model for the specified task is denoted C.

Iteration t of the reweighting algorithm's training procedure begins by sampling a batch {Xₛ, yₛ} of size bₛ from the N synthetic data samples and a batch {Xᵣ, yᵣ} of size by from the M real data samples. Data samples are denoted by X and their corresponding labels y. A forward pass is performed on the synthetic batch to obtain predictions ŷₛ=f(Xₛ,Øₜ), where Øₜ t are the model parameters at iteration t. An intermediate loss is computed according to Equation 1.

lₛ=Σᵢ₌₁^{b}^{ₛ}ϵᵢC(yₛ,i,ŷₛ,i), Equation 1
where ϵᵢ=0, ∀ᵢ∈{1, . . . , bₛ}.

A backward pass is performed to compute the gradient vector

$$∇ {l}_{s} = \frac{\partial {l}_{s}}{\partial {∅}_{t}} ,$$

and the model parameters are temporarily updated by Equation 2.

\hat{Ø}=Øₜ−α∇lₛ, Equation 2
where α is the meta-learning rate.

The vector E is set to all zeros to care only about the gradients Δlₛ but not the value of lₛ for the result of the algorithm. After updating the model parameters, a forward pass is performed on the real batch to obtain predictions ŷᵣ=f(Xᵣ,\hat{Ø}ₜ). A mean loss is computed for the real samples by Equation 3.

$${l}_{r} = \frac{1}{{b}_{r}} {\sum }_{i = 1}^{{b}_{r}} {ϵ}_{i} C ( {y}_{r} , i , {\hat{y}}_{r} , i ) \qquad Equation 3$$

The gradient vector

$$∇ {l}_{r} = \frac{\partial {l}_{r}}{{\partial }_{ϵ}}$$

is then computed by performing a backward-on-backward pass. Intermediate weights for the synthetic samples are determined as the negative of this gradient vector, but limited to a minimum of zero to prevent the weighted sum from blowing up, per Equation 4.

w=max(−lᵣ,0) Equation 4

The final weights are determined by batch-normalizing the weight values. The intuition behind this algorithm is that if wᵢ>wⱼ, a step in the gradient direction

$$\frac{\partial C ( {y}_{f} , i , {\hat{y}}_{f} , i )}{\partial {∅}_{t}}$$

will result in a larger decrease to the loss over the real data lₜ than a step in the gradient direction

$$\frac{\partial C ( {y}_{f} , j , {\hat{y}}_{f} , j )}{\partial {∅}_{t}} .$$

The final loss is computed as a weighted loss on the synthetic samples and is computed by Equation 5.

$${\hat{l}}_{s} = {\sum }_{i = 1}^{{b}_{s}} {w}_{i} C ( {y}_{s} , i , {\hat{y}}_{s} , i ) \qquad Equation 5$$

Synthetic samples are thus not simply the samples which are ‘closest’ to the real samples, but the samples which the model gathers the most information from about the downstream task represented in the real-world data. The reweighting algorithm's learned weights are batch-normalized. Thus to limit random effects, the weights are averaged across multiple epochs. While employing the reweighting algorithm to obtain weights on the synthetic dataset, training is performed for between 5-10 epochs and the weights are averaged. Averaging the weights over greater than 10 epochs results in relatively little variation when sorting the synthetic samples according to their final weight values.

The synthetic dataset is sorted such that wᵢ≥wⱼ for i<j. After sorting, the cumulative weight is defined as in Equation 6, which is a function of the dataset index.

$$W ( i ) = \frac{{\sum }_{k = 1}^{i} {w}_{k}}{{\sum }_{j = 1}^{N} {w}_{j}} \qquad Equation 6$$

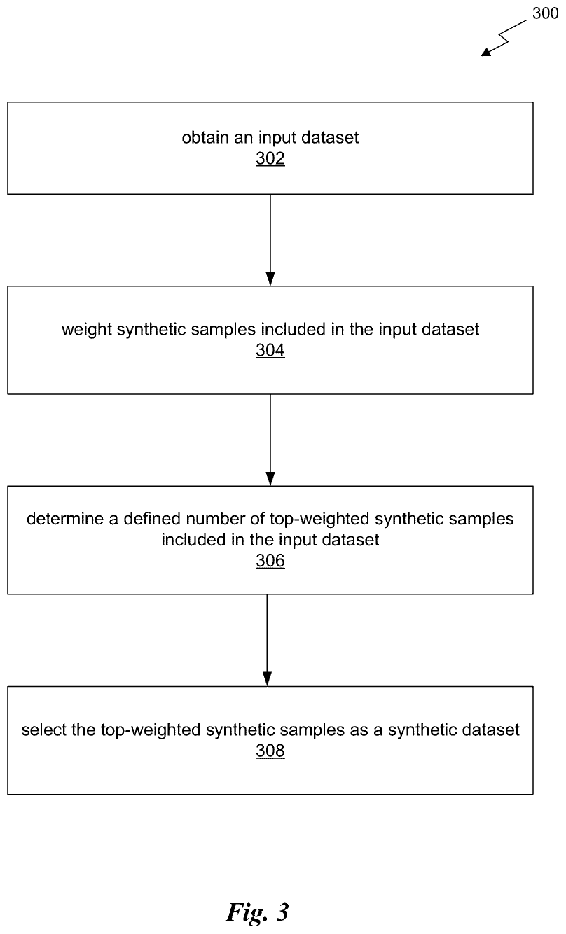

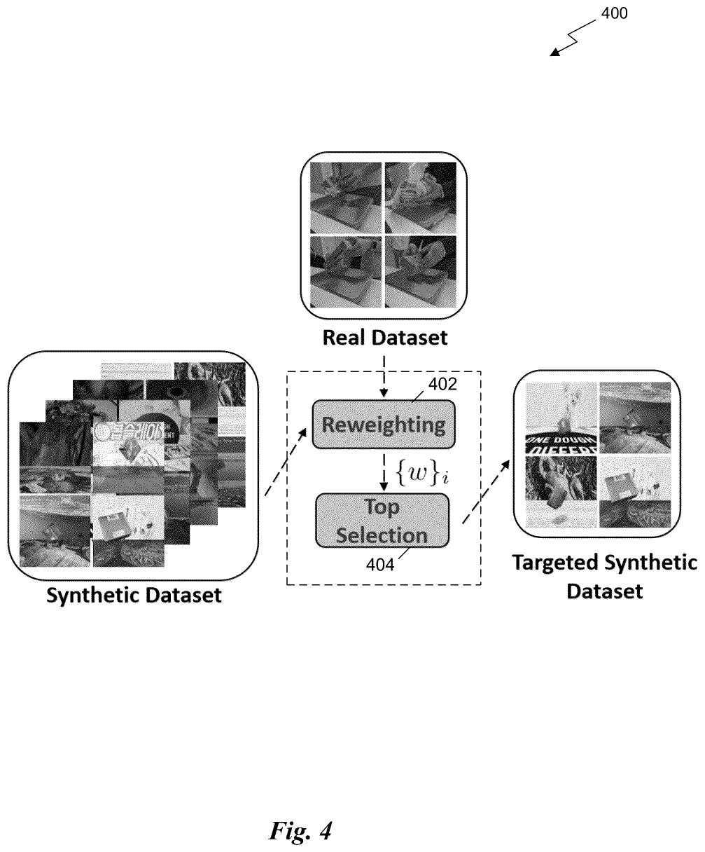

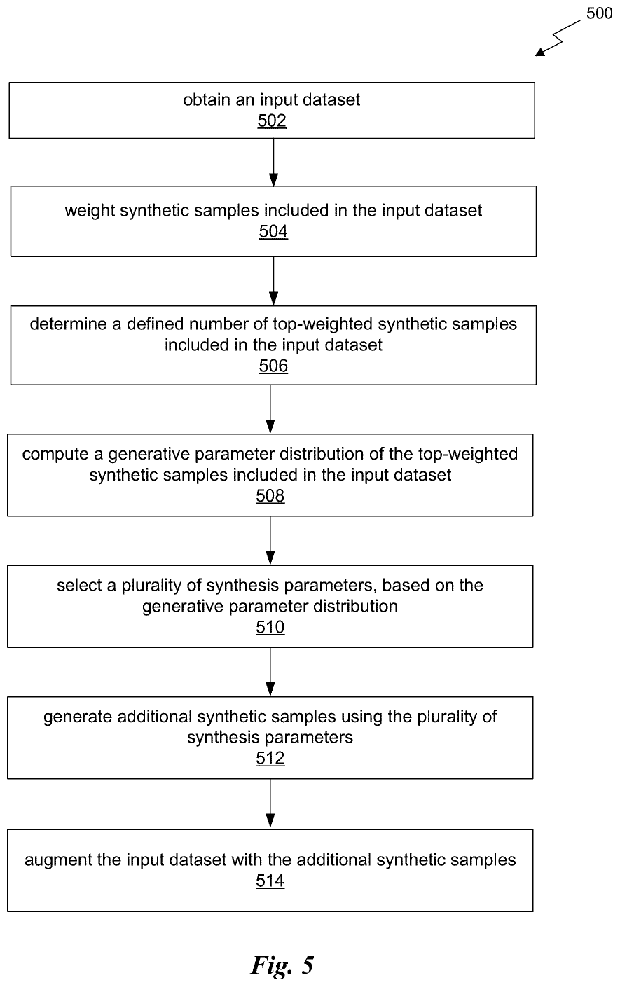

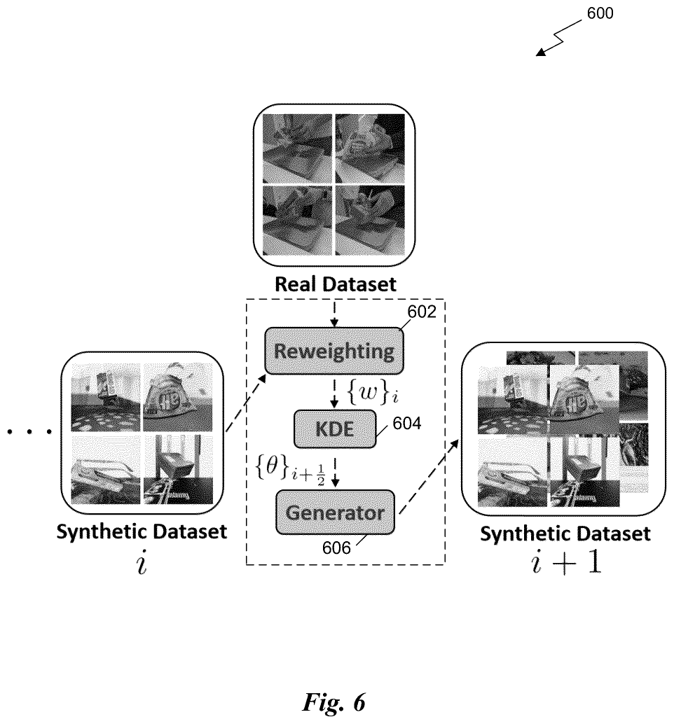

In some applications, most of the synthetic samples will correspond to small weight values after performing the reweighting algorithm. Embodiments described below aim to take advantage of this fact in two ways: (a) by neglecting or removing synthetic samples with low weight from the dataset as shown in FIGS. 3 and 4 (referred to herein as “dataset curation”), and (b) by attempting to generate additional data most similar to the highest weighted samples in a progressive fashion as shown in FIGS. 5 and 6 (referred to herein as “active synthesis”).

FIG. 3 illustrates a method 300 for curating an input dataset to form a synthetic dataset, in accordance with an embodiment. The method 300 may be performed in accordance with the method 100 of FIG. 1, and/or in the context of any of the other embodiments described herein. The definitions and embodiments described above may equally apply to the description of the present embodiment.

In operation 302, an input dataset is obtained (e.g. accessed from memory, etc.). In the present embodiment, the input dataset includes an input synthetic dataset. In operation 304, synthetic samples included in the input dataset are weighted. In an embodiment, the synthetic samples may be weighted using the method 200 of FIG. 2.

In operation 306, a defined number of top-weighted synthetic samples included in the input dataset are determined. In an embodiment, the defined number may be less than a number of the synthetic samples in the input dataset. It should be noted that the number of top-weighted synthetic samples to be determined may be predefined in any manner and/or based on any desired criteria.

In an embodiment, the synthetic samples may be ranked according to weight. The top-weighted synthetic samples may then be determined by selecting the defined number of top-ranked synthetic samples.

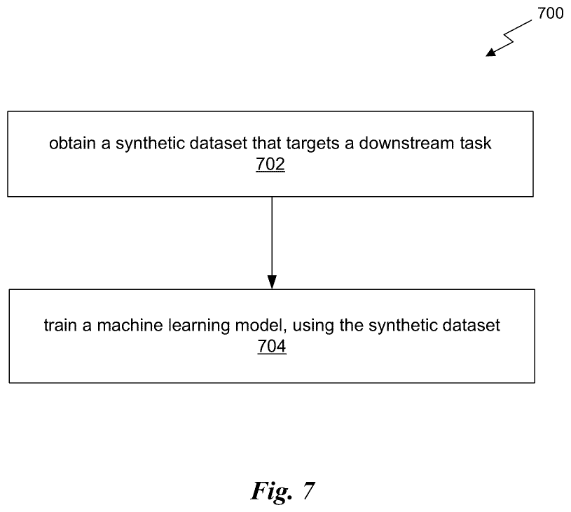

In operation 308, the top-weighted synthetic samples are selected as a synthetic dataset. In an embodiment, the top-weighted synthetic samples may be saved as a new synthetic dataset. In another embodiment, all synthetic samples in the input synthetic dataset that are not the top-weighted synthetic samples may be removed from the input synthetic dataset. The synthetic dataset may then be used to train a machine learning model, for example according to the method 700 of FIG. 7.

The method 300 may be referred to as a dataset curation, or in other words the curation of an optimal subset of a large dataset. The goal of dataset curation is to reduce a fully synthetic dataset of N samples to a synthetic dataset of n<N samples, which is targeted to some task by leveraging the information contained in a small dataset of M real samples. Reducing the size of the synthetic dataset in a principled manner is dual-purposed: when used to train a machine learning model (e.g. per the method 700 of FIG. 7), it increases training efficiency while improving performance of the final trained model.

FIG. 4 illustrates a flow diagram of a system 400 that curates a synthetic dataset from an input dataset, in accordance with an embodiment. The system 400 may be implemented to carry out the method 300 FIG. 3, and/or in the context of any of the other embodiments described herein. The definitions and embodiments described above may equally apply to the description of the present embodiment.

In an embodiment, there is some distribution p(θ) on the generative parameters to be used to create an input synthetic dataset. In the context of an input synthetic dataset that includes images, the generative parameters may include object orientation, image background, lighting, camera distance, etc. Suppose that a large synthetic dataset is created from a set {θⱼ}ⱼ₌₁^{N} consisting of N samples where all θⱼ are i.i.d and θⱼ˜p(θ). With a generic generator G and some p(θ), the synthetic dataset generated will likely not be optimal for the task at hand. Often generating more synthetic samples in a random manner can improve performance, but only up to certain number of samples. After this point, generating even more additional data not only decreases training efficiency, but also decreases performance.

The present system 200 provides for a dataset curation of the input synthetic dataset. As shown, the input dataset includes both an input synthetic dataset and an input real world dataset. The input synthetic dataset may have more samples than the input real world dataset.

To curate a smaller synthetic subset from the larger input synthetic dataset, a reweighting algorithm component 402 executes on a small number of epochs of the (larger) input synthetic dataset to obtain a set of weights corresponding to each sample in it {wᵢ}. A top selection component 404 sorts the input synthetic dataset samples according to their weight to determine a defined number of the top-weighted samples, and then removes the lowest-weighted samples from the input synthetic dataset. The new (smaller) synthetic subsets are extracted as the set of all samples with indices in the set {i|W(i)<Ŵ}, to form a targeted synthetic dataset, as shown. Finally, a model may be trained on the smaller curated (target) synthetic dataset, for example per the method 700 of FIG. 7.

FIG. 5 illustrates a method for actively synthesizing an input dataset to form a smaller synthetic dataset, in accordance with an embodiment. The method 200 may be performed in accordance with the method 100 of FIG. 1, and/or in the context of any of the other embodiments described herein. The definitions and embodiments described above may equally apply to the description of the present embodiment.

In operation 502, an input dataset is obtained (e.g. accessed from memory, etc.). In the present embodiment, the input dataset includes an input synthetic dataset. In operation 504, synthetic samples included in the input dataset are weighted. In an embodiment, the synthetic samples may be weighted using the method 200 of FIG. 2.

In operation 506, a defined number of top-weighted synthetic samples included in the input dataset are determined. In an embodiment, the defined number may be less than a number of the synthetic samples in the input dataset. It should be noted that the number of top-weighted synthetic samples to be determined may be predefined in any manner and/or based on any desired criteria.

In an embodiment, the synthetic samples may be ranked according to weight. The top-weighted synthetic samples may then be determined by selecting the defined number of top-ranked synthetic samples.

In operation 508, a generative parameter distribution of the top-weighted synthetic samples included in the input dataset is determined. The generative parameter distribution refers to a distribution of the generative parameters used to generate the top-weighted synthetic samples. The generative parameter distribution includes a kernel density estimation (KDE), in an embodiment.

In operation 510, a plurality of synthesis parameters are selected based on the generative parameter distribution. The synthesis parameters refer to (a set of) the generative parameters used to generate the input synthetic dataset. The synthesis parameters are selected in particular based on the generative parameter distribution. In an embodiment, a set of sampling locations is obtained (predicted) by sampling from the generative parameter distribution.

In operation 512, additional synthetic samples are generated using the plurality of synthesis parameters. In operation 514, the input dataset is augmented with the additional synthetic samples. In particular, the additional synthetic samples may be added to the input synthetic dataset. As an option, the input synthetic dataset having the additional synthetic samples may then be curated according to the method 300 of FIG. 3.

The method 500 may be referred to as active dataset synthesis, or in other words obtaining the optimal synthetic data by incrementally generating additional data targeted to the downstream task to add to an initial (small) input synthetic dataset. In an embodiment, a plurality of iterations of the method 500 may be performed to grow the initial input synthetic dataset and thereby form the final synthetic dataset, which, when used to train a machine learning model (e.g. per the method 700 of FIG. 7), may maximally improve model performance.

FIG. 6 illustrates a flow diagram of a system 600 that actively synthesizes a synthetic dataset from an input dataset, in accordance with an embodiment. The system 600 may be implemented to carry out the method 500 FIG. 5, and/or in the context of any of the other embodiments described herein. The definitions and embodiments described above may equally apply to the description of the present embodiment.

Similar to the system 400 of FIG. 4, there is some distribution p(θ) on the generative parameters used to create an input synthetic dataset. Beginning with a small synthetic dataset of no samples corresponding to a set of generative parameters {θ}₀ sampled from p₀(θ), the system 400 iteratively augments the set with additional synthetic data generated from a generic generator G.

At iteration i, a reweighting algorithm component 602 executes on a number of epochs of the input synthetic dataset to obtain a set of weights corresponding to each sample in it {wᵢ}. Thus, the importance weights {wᵢ} are determined for the synthetic dataset {θ}_{I} for some specified task using a small set of labeled real world samples. The reweighting component 602 sorts the input synthetic dataset according to the computed importance weights, and then approximates the generative parameter distribution of a defined number of the top-weighted samples, which is denoted as pᵢ₊₁(θ). The KDE 604 is formed only on the set {θᵢ|W(i)≤Ŵ} of the generative parameters corresponding to the highest weighted samples, where Ŵ is a hyperparameter. A set of aᵢ sampling locations {θ}_{i+1/2} is predicted, where αᵢ=nᵢ−nᵢ₋₁. In particular, the set {θ}_{i+1/2} is obtained (predicted) by sampling aᵢ times from the generative parameter distribution pᵢ₊₁(θ).

The new augmented set of sampling locations {θ}ᵢ₊₁={θ}ᵢ∪{θ}_{i+1/2} is constructed by combining the sampling locations from the previous iteration and the newly predicted sampling locations. A generator component 606, which may be G mentioned above, is used to generate new synthetic data from the predicted sampling locations {θ}_{i+1/2}, and the input synthetic dataset is augmented with the newly generated samples. In an embodiment, the dataset curation method 300 described with respect to FIG. 3 may be used to trim the dataset at each iteration i before training a model, for example per the method 700 of FIG. 7.

FIG. 7 illustrates a method 700 for using a machine learning model in a downstream task, in accordance with an embodiment. The method 700 may be performed in the context of any of the embodiments described herein. The definitions and embodiments described above may equally apply to the description of the present embodiment.

In operation 702, a synthetic dataset that targets a downstream task is obtained. In an embodiment, the synthetic dataset may be generated according to the method 100 of FIG. 1 and/or in the context of any of the other methods and systems described herein. For example, the synthetic dataset may be curated from a larger input synthetic dataset (e.g. per the method 300 of FIG. 3 and/or the system 400 of FIG. 4). As another example, the synthetic dataset may be synthesized from a smaller input synthetic dataset (e.g. per the method 500 of FIG. 5 and/or the system 600 of FIG. 6).

In operation 704, a machine learning model is trained, using the synthetic dataset. In an embodiment, the machine learning model may be trained using supervised learning. In another embodiment, the machine learning model may be trained using unsupervised learning. In any case, the trained machine learning model may be used for the downstream task.

In one exemplary embodiment, the machine learning model may be trained for retail object detection. For example, the machine learning model may predict a bounding box of various retail items from an input image with a single object instance. In this exemplary embodiment, an input dataset may include an input synthetic dataset formed by a three-dimensional (3D) scan of a plurality of retail objects, from which images of each object are rendered using a plurality of patterns of randomization. In each pattern, a 3D model of a retail object may be first loaded into the scene as the main object, and then the object's translation, orientation, and scale are randomized, and the rendered image and its bounding box are recorded. The generation parameters (e.g. light intensity, object size, object translation, object orientation) may also be saved for each synthetic sample in the dataset. The input synthetic dataset may then be processed (e.g. per the method 100 of FIG. 1) to form the synthetic dataset on which the machine learning model is ultimately trained.

In another exemplary embodiment, the machine learning model may be trained for gaze estimation. For example, the machine learning model may regress eye gaze direction from input eye images. In this exemplary embodiment, an input dataset may include an input synthetic dataset that includes synthetic images of eyes placed on randomly generated face shapes (i.e. per a randomization of face region parameters). The input synthetic dataset may then be processed (e.g. per the method 100 of FIG. 1) to form the synthetic dataset on which the machine learning model is ultimately trained.

In a further exemplary embodiment, the machine learning model may be trained for natural language processing for a target language. For example, the machine learning model may predict a meaning from a given language-based input. In this exemplary embodiment, an input dataset may include an input synthetic dataset that includes language-based samples in multiple spoken languages. The input synthetic dataset may then be processed (e.g. per the method 100 of FIG. 1) to form the synthetic dataset on which the machine learning model is ultimately trained for the target language.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where α trained neural network is applied to new inputs it has not seen before to classify images, translate speech, and generally infer new information.

### Inference and Training Logic

As noted above, a deep learning or neural learning system needs to be trained to generate inferences from input data. Details regarding inference and/or training logic 815 for a deep learning or neural learning system are provided below in conjunction with FIGS.. 8A and/or 8B.

In at least one embodiment, inference and/or training logic 815 may include, without limitation, a data storage 801 to store forward and/or output weight and/or input/output data corresponding to neurons or layers of a neural network trained and/or used for inferencing in aspects of one or more embodiments. In at least one embodiment data storage 801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 801 may be included with other on-chip or off-chip data storage, including a processor's L1, L2, or L3 cache or system memory.

In at least one embodiment, any portion of data storage 801 may be internal or external to one or more processors or other hardware logic devices or circuits. In at least one embodiment, data storage 801 may be cache memory, dynamic randomly addressable memory (“DRAM”), static randomly addressable memory (“SRAM”), non-volatile memory (e.g., Flash memory), or other storage. In at least one embodiment, choice of whether data storage 801 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 815 may include, without limitation, a data storage 805 to store backward and/or output weight and/or input/output data corresponding to neurons or layers of a neural network trained and/or used for inferencing in aspects of one or more embodiments. In at least one embodiment, data storage 805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 805 may be included with other on-chip or off-chip data storage, including a processor's L1, L2, or L3 cache or system memory. In at least one embodiment, any portion of data storage 805 may be internal or external to on one or more processors or other hardware logic devices or circuits. In at least one embodiment, data storage 805 may be cache memory, DRAM, SRAM, non-volatile memory (e.g., Flash memory), or other storage. In at least one embodiment, choice of whether data storage 805 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 801 and data storage 805 may be separate storage structures. In at least one embodiment, data storage 801 and data storage 805 may be same storage structure. In at least one embodiment, data storage 801 and data storage 805 may be partially same storage structure and partially separate storage structures. In at least one embodiment, any portion of data storage 801 and data storage 805 may be included with other on-chip or off-chip data storage, including a processor's L1, L2, or L3 cache or system memory.

In at least one embodiment, inference and/or training logic 815 may include, without limitation, one or more arithmetic logic unit(s) (“ALU(s)”) 810 to perform logical and/or mathematical operations based, at least in part on, or indicated by, training and/or inference code, result of which may result in activations (e.g., output values from layers or neurons within a neural network) stored in an activation storage 820 that are functions of input/output and/or weight parameter data stored in data storage 801 and/or data storage 805. In at least one embodiment, activations stored in activation storage 820 are generated according to linear algebraic and or matrix-based mathematics performed by ALU(s) 810 in response to performing instructions or other code, wherein weight values stored in data storage 805 and/or data 801 are used as operands along with other values, such as bias values, gradient information, momentum values, or other parameters or hyperparameters, any or all of which may be stored in data storage 805 or data storage 801 or another storage on or off-chip. In at least one embodiment, ALU(s) 810 are included within one or more processors or other hardware logic devices or circuits, whereas in another embodiment, ALU(s) 810 may be external to a processor or other hardware logic device or circuit that uses them (e.g., a co-processor). In at least one embodiment, ALUs 810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 801, data storage 805, and activation storage 820 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

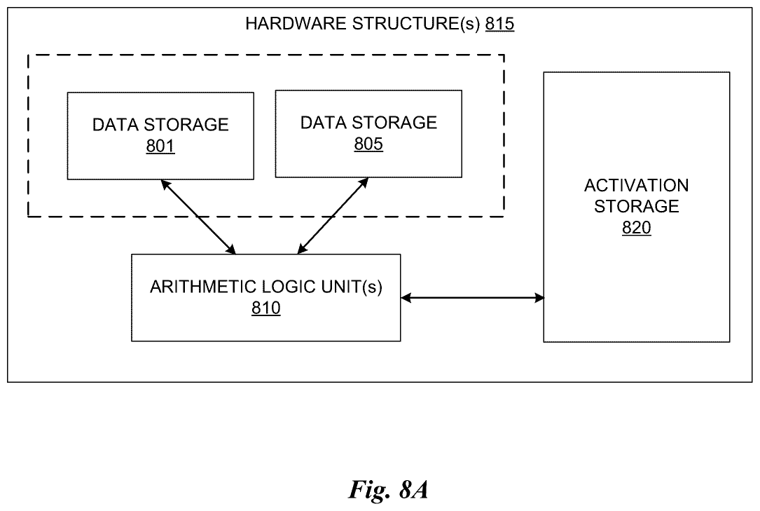

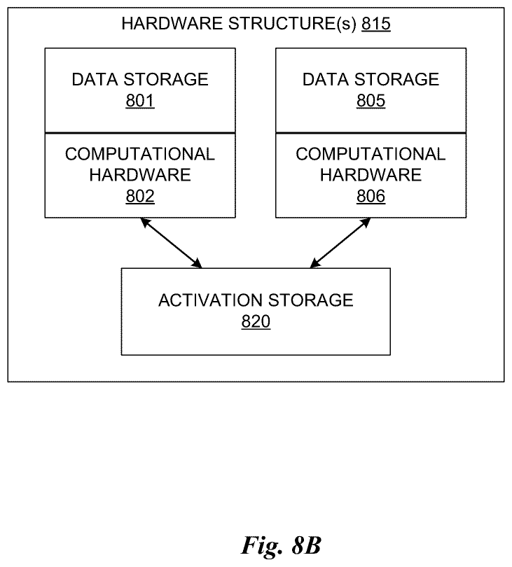

In at least one embodiment, activation storage 820 may be cache memory, DRAM, SRAM, non-volatile memory (e.g., Flash memory), or other storage. In at least one embodiment, activation storage 820 may be completely or partially within or external to one or more processors or other logical circuits. In at least one embodiment, choice of whether activation storage 820 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 815 illustrated in FIG. 8A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8A may be used in conjunction with central processing unit (“CPU”) hardware, graphics processing unit (“GPU”) hardware or other hardware, such as field programmable gate arrays (“FPGAs”).

FIG. 8B illustrates inference and/or training logic 815, according to at least one embodiment. In at least one embodiment, inference and/or training logic 815 may include, without limitation, hardware logic in which computational resources are dedicated or otherwise exclusively used in conjunction with weight values or other information corresponding to one or more layers of neurons within a neural network. In at least one embodiment, inference and/or training logic 815 illustrated in FIG. 8B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8B may be used in conjunction with central processing unit (CPU) hardware, graphics processing unit (GPU) hardware or other hardware, such as field programmable gate arrays (FPGAs). In at least one embodiment, inference and/or training logic 815 includes, without limitation, data storage 801 and data storage 805, which may be used to store weight values and/or other information, including bias values, gradient information, momentum values, and/or other parameter or hyperparameter information. In at least one embodiment illustrated in FIG. 8B, each of data storage 801 and data storage 805 is associated with a dedicated computational resource, such as computational hardware 802 and computational hardware 806, respectively. In at least one embodiment, each of computational hardware 806 comprises one or more ALUs that perform mathematical functions, such as linear algebraic functions, only on information stored in data storage 801 and data storage 805, respectively, result of which is stored in activation storage 820.

In at least one embodiment, each of data storage 801 and 805 and corresponding computational hardware 802 and 806, respectively, correspond to different layers of a neural network, such that resulting activation from one “storage/computational pair 801/802” of data storage 801 and computational hardware 802 is provided as an input to next “storage/computational pair 805/806” of data storage 805 and computational hardware 806, in order to mirror conceptual organization of a neural network. In at least one embodiment, each of storage/computational pairs 801/802 and 805/806 may correspond to more than one neural network layer. In at least one embodiment, additional storage/computation pairs (not shown) subsequent to or in parallel with storage computation pairs 801/802 and 805/806 may be included in inference and/or training logic 815.

### Neural Network Training and Deployment

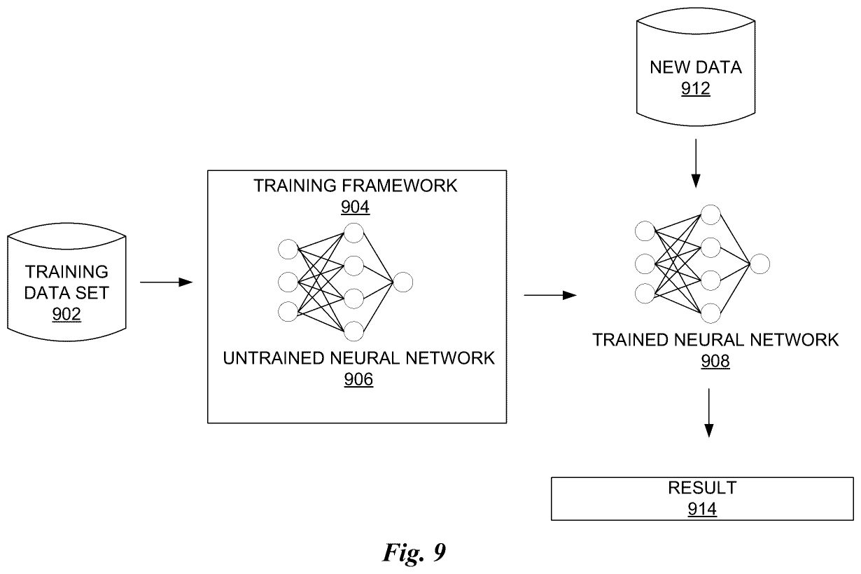

FIG. 9 illustrates another embodiment for training and deployment of a deep neural network. In at least one embodiment, untrained neural network 906 is trained using a training dataset 902. In at least one embodiment, training framework 904 is a PyTorch framework, whereas in other embodiments, training framework 904 is a Tensorflow, Boost, Caffe, Microsoft Cognitive Toolkit/CNTK, MXNet, Chainer, Keras, Deeplearning4j, or other training framework. In at least one embodiment training framework 904 trains an untrained neural network 906 and enables it to be trained using processing resources described herein to generate a trained neural network 908. In at least one embodiment, weights may be chosen randomly or by pre-training using a deep belief network. In at least one embodiment, training may be performed in either a supervised, partially supervised, or unsupervised manner.

In at least one embodiment, untrained neural network 906 is trained using supervised learning, wherein training dataset 902 includes an input paired with a desired output for an input, or where training dataset 902 includes input having known output and the output of the neural network is manually graded. In at least one embodiment, untrained neural network 906 is trained in a supervised manner processes inputs from training dataset 902 and compares resulting outputs against a set of expected or desired outputs. In at least one embodiment, errors are then propagated back through untrained neural network 906. In at least one embodiment, training framework 904 adjusts weights that control untrained neural network 906. In at least one embodiment, training framework 904 includes tools to monitor how well untrained neural network 906 is converging towards a model, such as trained neural network 908, suitable to generating correct answers, such as in result 914, based on known input data, such as new data 912. In at least one embodiment, training framework 904 trains untrained neural network 906 repeatedly while adjust weights to refine an output of untrained neural network 906 using a loss function and adjustment algorithm, such as stochastic gradient descent. In at least one embodiment, training framework 904 trains untrained neural network 906 until untrained neural network 906 achieves a desired accuracy. In at least one embodiment, trained neural network 908 can then be deployed to implement any number of machine learning operations.

In at least one embodiment, untrained neural network 906 is trained using unsupervised learning, wherein untrained neural network 906 attempts to train itself using unlabeled data. In at least one embodiment, unsupervised learning training dataset 902 will include input data without any associated output data or “ground truth” data. In at least one embodiment, untrained neural network 906 can learn groupings within training dataset 902 and can determine how individual inputs are related to untrained dataset 902. In at least one embodiment, unsupervised training can be used to generate a self-organizing map, which is a type of trained neural network 908 capable of performing operations useful in reducing dimensionality of new data 912. In at least one embodiment, unsupervised training can also be used to perform anomaly detection, which allows identification of data points in a new dataset 912 that deviate from normal patterns of new dataset 912.

In at least one embodiment, semi-supervised learning may be used, which is a technique in which in training dataset 902 includes a mix of labeled and unlabeled data. In at least one embodiment, training framework 904 may be used to perform incremental learning, such as through transferred learning techniques. In at least one embodiment, incremental learning enables trained neural network 908 to adapt to new data 912 without forgetting knowledge instilled within network during initial training.

### Data Center

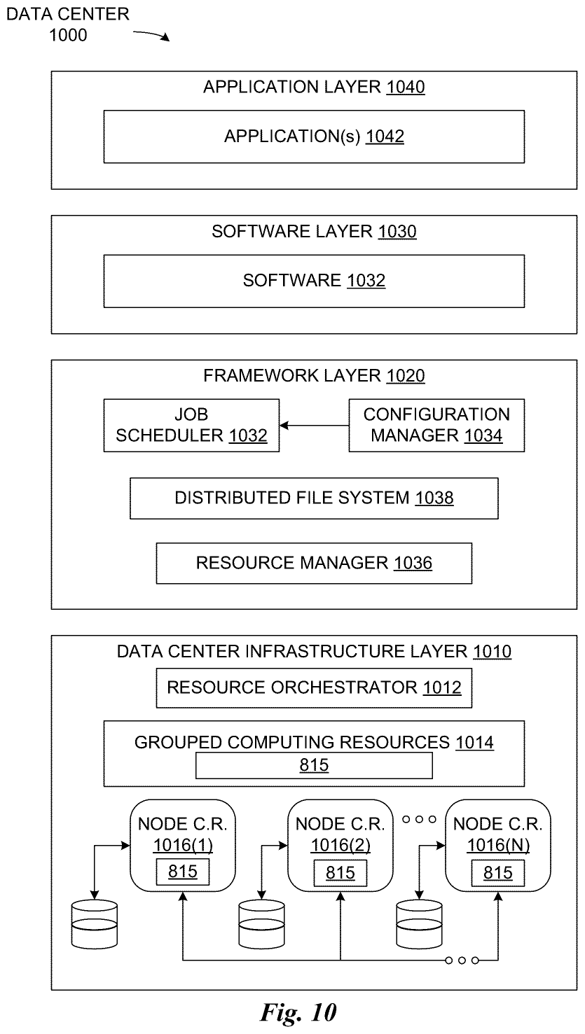

FIG. 10 illustrates an example data center 1000, in which at least one embodiment may be used. In at least one embodiment, data center 1000 includes a data center infrastructure layer 1010, a framework layer 1020, a software layer 1030 and an application layer 1040.

In at least one embodiment, as shown in FIG. 10, data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1016(1)-1016(N) may be a server having one or more of above-mentioned computing resources.

In at least one embodiment, grouped computing resources 1014 may include separate groupings of node C.R.s housed within one or more racks (not shown), or many racks housed in data centers at various geographical locations (also not shown). Separate groupings of node C.R.s within grouped computing resources 1014 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1022 may configure or otherwise control one or more node C.R.s 1016(1)-1016(N) and/or grouped computing resources 1014. In at least one embodiment, resource orchestrator 1022 may include a software design infrastructure (“SDI”) management entity for data center 1000. In at least one embodiment, resource orchestrator may include hardware, software or some combination thereof.

In at least one embodiment, as shown in FIG. 10, framework layer 1020 includes a job scheduler 1032, a configuration manager 1034, a resource manager 1036 and a distributed file system 1038. In at least one embodiment, framework layer 1020 may include a framework to support software 1032 of software layer 1030 and/or one or more application(s) 1042 of application layer 1040. In at least one embodiment, software 1032 or application(s) 1042 may respectively include web-based service software or applications, such as those provided by Amazon Web Services, Google Cloud and Microsoft Azure. In at least one embodiment, framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1032 may include a Spark driver to facilitate scheduling of workloads supported by various layers of data center 1000. In at least one embodiment, configuration manager 1034 may be capable of configuring different layers such as software layer 1030 and framework layer 1020 including Spark and distributed file system 1038 for supporting large-scale data processing. In at least one embodiment, resource manager 1036 may be capable of managing clustered or grouped computing resources mapped to or allocated for support of distributed file system 1038 and job scheduler 1032. In at least one embodiment, clustered or grouped computing resources may include grouped computing resource 1014 at data center infrastructure layer 1010. In at least one embodiment, resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. one or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. In at least one embodiment, self-modifying actions may relieve a data center operator of data center 1000 from making possibly bad configuration decisions and possibly avoiding underutilized and/or poor performing portions of a data center.

In at least one embodiment, data center 1000 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1000. In at least one embodiment, trained machine learning models corresponding to one or more neural networks may be used to infer or predict information using resources described above with respect to data center 1000 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 815 are used to perform inferencing and/or training operations associated with one or more embodiments. In at least one embodiment, inference and/or training logic 815 may be used in system FIG. 10 for inferencing or predicting operations based, at least in part, on weight parameters calculated using neural network training operations, neural network functions and/or architectures, or neural network use cases described herein.

As described herein with reference to FIGS. 1-7, a method, computer readable medium, and system are disclosed for generating a synthetic dataset which targets a specified downstream task and which can then be used to train a machine learning model for the downstream task. The machine learning model may be is stored (partially or wholly) in one or both of data storage 801 and 805 in inference and/or training logic 815 as depicted in FIGS. 8A and 8B. Training and deployment of the machine learning model may be performed as depicted in FIG. 9 and described herein. Distribution of the machine learning model may be performed using one or more servers in a data center 1000 as depicted in FIG. 10 and described herein.

What is claimed is:

1. A method comprising:
at a device:
processing an input dataset to generate a synthetic dataset that is targeted to a specified downstream task; and
outputting the synthetic dataset.

2. The method of claim 1, wherein the input dataset includes:
an input synthetic dataset, and
an input real world dataset.

3. The method of claim 1, wherein the input dataset includes labeled samples.

4. The method of claim 1, wherein the input synthetic dataset includes a greater number of samples than the input real world dataset.

5. The method of claim 1, wherein the processing is performed using a meta-learning algorithm.

6. The method of claim 5, wherein the meta-learning algorithm reweights a plurality of synthetic samples included in the input dataset.

7. The method of claim 1, wherein processing the input dataset includes learning, with respect to the target downstream task for each of a plurality of synthetic samples included in the input dataset, an importance of the synthetic sample and its generation parameters.

8. The method of claim 7, wherein the importance is indicated as a weight.

9. The method of claim 7, wherein the synthetic dataset is generated based on the importance learned for each of the plurality of synthetic samples included in the input dataset.

10. The method of claim 1, wherein the synthetic dataset is curated from the input dataset.

11. The method of claim 10, wherein the synthetic dataset is curated from the input dataset by:
determining a defined number of top-weighted synthetic samples included in the input dataset, and
selecting the top-weighted synthetic samples as the synthetic dataset.

12. The method of claim 1, wherein the synthetic dataset is actively synthesized from the input dataset.

13. The method of claim 12, wherein the synthetic dataset includes newly generated synthetic samples that augment the input dataset.

14. The method of claim 13, wherein the newly generated synthetic samples include additional synthetic samples generated over a plurality of iterations.

15. The method of claim 13, wherein the newly generated synthetic samples include additional synthetic samples generated by:
determining a defined number of top-weighted synthetic samples included in the input dataset,
computing a generative parameter distribution of the top-weighted synthetic samples included in the input dataset,
selecting a plurality of synthesis parameters, based on the generative parameter distribution, and
generating the additional synthetic samples based on the plurality of synthesis parameters.

16. The method of claim 1, wherein the target downstream task is a computer vision task.

17. The method of claim 1, wherein the target downstream task is a natural language processing task.

18. The method of claim 1, wherein the synthetic dataset is output as a training dataset for training a machine learning model for the target downstream task.

19. The method of claim 18, the method further comprising:
training the machine learning model for the target downstream task, using the synthetic dataset.

20. A system, comprising:
a non-transitory memory storage comprising instructions; and
one or more processors in communication with the memory, wherein the one or more processors execute the instructions to:
process an input dataset to generate a synthetic dataset that is targeted to a specified downstream task; and
output the synthetic dataset.

21. A non-transitory computer-readable media storing computer instructions which when executed by one or more processors of a device cause the device to:
process an input dataset to generate a synthetic dataset that is targeted to a specified downstream task; and
output the synthetic dataset.
